(19) United States
(12) Patent Application Publication
(10) Pub. No.: US 2003/0157961 A1
(43) Pub. Date: Aug. 21, 2003

(54) Peripheral data entry device with integrated wireless modem

(76) Inventor: Kenneth Matthew Glover, Coppell, TX (US)

Correspondence Address: Raffi Gostanian, Jr., Jackson Walker L.L.P., Suite 600, 2435 North Central Expressway, Richardson, TX, 75080, US

(21) Appl. No.: 10/078,576

(22) Filed: Feb. 19, 2002

(51) Int. Cl. H04M 1/00

(52) U.S. Cl. 455/557; 455/556

(57) ABSTRACT

The present invention provides a peripheral data entry device that comprises a housing including an interface adapted to couple to a digital device, a processor disposed in the housing and coupled to the interface via a serial interface, a data entry module, and a wireless modem disposed in the housing and adapted to wirelessly receive information from a data network, where the data entry module and the wireless modem are attachable to the processor via a serial interface. The processor is adapted to receive data entry module input via the data entry module, receive the wireless information via the wireless modem, multiplex the received data entry module input and the received wireless information, and transmit the multiplexed data entry module input and wireless information to the digital device via the interface.

### FIELD OF THE INVENTION

The present invention relates to peripheral data entry devices and, more particularly, to a peripheral data entry device with an integrated wireless modem.

### BACKGROUND OF THE INVENTION

Conventional peripheral data entry devices provide a user with the ability to input data into a system and, based on the inputted data, initiate, alter or end an application depicted on the peripheral. For example, a standard QWERTY keypad or keyboard can be used by a user to input data that is received by a system (such as a computer) which alters an application (such as a document) depicted on the peripheral (such as a computer monitor).

For mobile applications, various peripheral data entry devices exist such as, for example, a keypad found on a personal computing device such as a Personal Digital Assistant (PDA). Although such a keypad provides the user with various input command options, it is typically small and cumbersome to use. As such, a data entry device that can connect to a PDA that is easier to use would be beneficial.

Various keyboards for use with a PDA currently exist. They include thumb keyboards, undersized keyboards, and full-sized keyboards. Thumb keyboards are a good substitute for using a PDA's “graffiti” or on-screen keyboard but are too slow if entering multiple sentences. Undersized keyboards are easier to use than thumb keyboards but result in reduced accuracy and slower typing. Full-sized keyboards, which can be folded and made compact when not in use, allow for “touch-typing” thereby allowing a user to type with all of their fingers similarly to a desktop computer keyboard. Benefits include greater accuracy, faster typing, fewer errors, and no learning curve.

Another peripheral data entry device for use with a PDA includes a gamming keyboard or pad which allows a user to play games on their PDA using a more comfortable and easy to use button arrangement (such as those found, for example, on a “Game Boy”).

Various limitations exist, however, with the gamming pad and keyboard data entry devices for use with a PDA. For example, wireless data access is not provided as a function of the data entry devices and thus the use of a PDA with a portable keyboard and a “sled/cradle” with a PC Card modem that connects to the PDA are necessary. Wireless data access can also be provided via cables tethered to a mobile handset or, for a gamming application, via a PDA with a gaming attachment tethered to a wireless handset. These are bulky wireless data access solutions that require multiple components and, on certain platforms, operating system constraints may impede the ability to provide wireless data access. Further, these conventional solutions require the PDA to utilize its serial interface thus limiting the ability of the PDA to perform additional functionality or provide increased options to the user.

Therefore, it is desirable for the present invention to overcome the aforementioned limitations associated with conventional peripheral data entry devices.

### SUMMARY OF THE INVENTION

The present invention achieves technical advantages as a peripheral data entry device with an integrated wireless modem and as a method for data delivery. Advantages are achieved via a wireless modem that is integrated into the data entry device and via serial interface lines contained within the data entry device that provide the data entry and wireless modem functions.

In an exemplary embodiment, a peripheral data entry device comprises a housing including an interface adapted to couple to a digital device, a processor disposed in the housing and coupled to the interface via a serial interface, a data entry module, and a wireless modem disposed in the housing and adapted to wirelessly receive information from a data network, where the data entry module and the wireless modem are attachable to the processor via a serial interface. The processor is adapted to receive data entry module input via the data entry module, receive the wireless information via the wireless modem, multiplex the received data entry module input and the received wireless information, and transmit the multiplexed data entry module input and wireless information to the digital device via the interface.

In another embodiment, a method for data delivery comprises receiving a first set of data from a first module, wirelessly receiving a second set of data from a second module, the second module being disposed in the first module, combining the first set of data and the second set of data, and transmitting the combined sets of data to a third module.

In a further embodiment, another method for data delivery comprises transmitting data from a third module to a second module, the second module being disposed in a first module, wirelessly transmitting the data from the second module to a data network, wirelessly receiving network data from the network, by the second module, based on the wirelessly transmitted data, transmitting first module data from the first module based on the wirelessly received network data, and contemporaneously receiving, by the third module, the network data and the first module data.

### BRIEF DESCRIPTION OF THE DRAWINGS

FIG. 1 illustrates a wireless modem integrated with a gaming based peripheral data entry device attached to a personal digital assistant in accordance with an exemplary embodiment of the present invention.

FIG. 2 illustrates a wireless modem integrated with a keyboard based peripheral data entry device attached to a personal digital assistant in accordance with an exemplary embodiment of the present invention.

FIG. 3 illustrates a block diagram of the peripheral data entry device coupled to the PDA in accordance with an exemplary embodiment of the present invention.

FIG. 4 illustrates a flow chart for data delivery in accordance with an exemplary embodiment of the present invention.

FIG. 5 illustrates another flow chart for data delivery in accordance with an exemplary embodiment of the present invention.

### DETAILED DESCRIPTION OF THE INVENTION

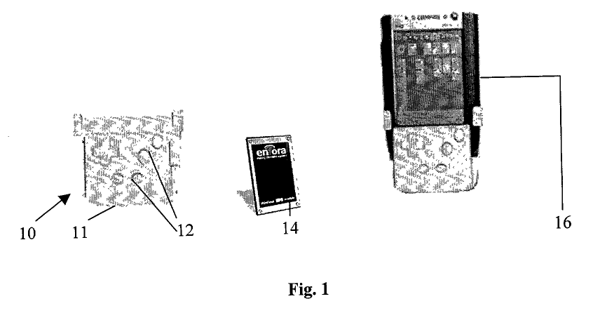

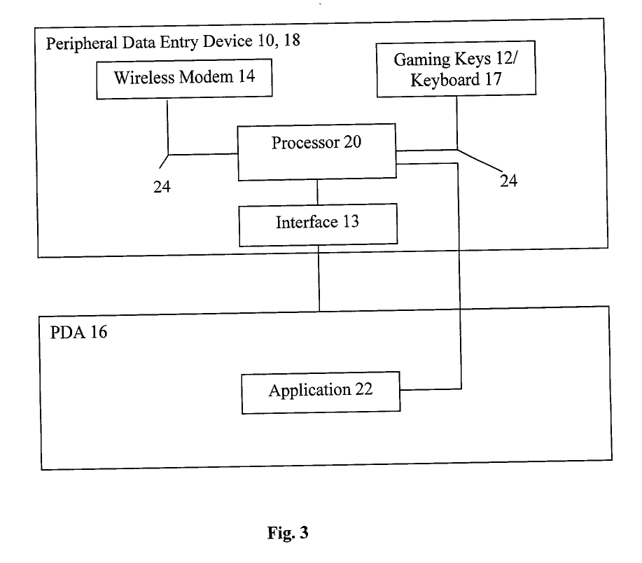

Referring now to FIG. 1, a gaming based peripheral data entry device 10 is depicted which fully contains a wireless modem 14. The wireless modem may be a wireless wide-area modem for use in a wireless wide-area network that provides access to a data/IP network, such as the Internet, for download of games and/or online play. An example of such a modem is the “Enabler-C” or the “Enabler-G”, both developed by Enfora. The gaming based peripheral data entry device 10 includes a housing 11 and gaming keys 12 and is attachable to a PDA 16. A more complete description of the gaming based peripheral data entry device 10 will be described in relation to FIG. 3 below.

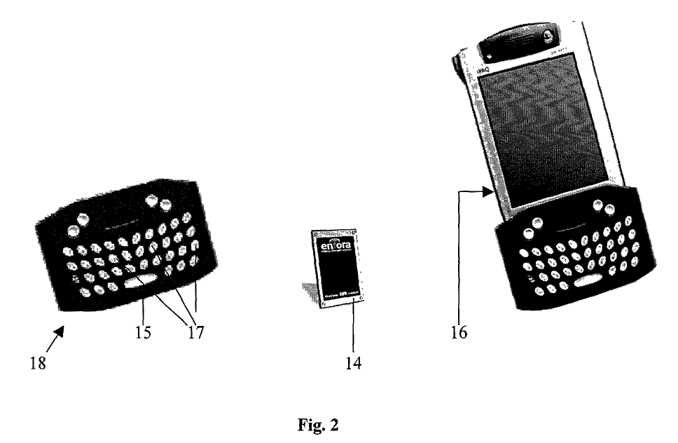

Referring now to FIG. 2, a keyboard based peripheral data entry device 18 is depicted which, similarly to the gaming based peripheral data entry device 10, fully contains the wireless modem 14, a housing 15 and keyboard 17 and is attachable to a PDA 16. A more complete description of the gaming based peripheral data entry device 10 will be described in relation to FIG. 3 below.

Referring now to FIG. 3, a block diagram of the gaming based peripheral data entry device 10 and/or the keyboard based peripheral data entry device 18 (peripheral data entry device) coupled to the PDA 16 is depicted. The peripheral data entry device comprises a housing 11 (gaming based) or a housing 15 (keyboard based) that includes an interface 13 adapted to couple to the PDA 16. The PDA 16 is “slid-into” a slot or opening in the housing (not shown) such that the PDA's serial port (not shown) is coupled to the interface 13. The peripheral data entry device further comprises gaming keys 12 (gaming based) or a keyboard 15 (keyboard based) as well as a processor 20 disposed in the housing and coupled to the interface 13. The processor 20 may be a micro-processor, a micro-controller, a digital signal processor, and/or any device that processes digital and/or analog information. The peripheral data entry device also comprises a wireless modem 14 disposed in the housing 11, 15, adapted to wirelessly receive information from a data network (not shown) and being coupled to the processor 20, along with the gaming keys 12/keyboard 17, via serial interfaces (serial interface lines) 24. The peripheral data entry device is adapted to contain the necessary serial interface lines 24 required to provide input capability and wireless modem functions.

The processor 20 is adapted to (being adapted to) receive gaming input/keyboard input (input) via the gaming keys 12 and the keyboard 17, respectively, receive the wireless information via the wireless modem 14, combine or multiplex the received input and the received wireless information, and transmit the multiplexed input and wireless information to the PDA 16 via the interface 13. The processor 20 facilitates the communication interfaces between the wireless modem 14 and the gaming keys 12/keyboard 17. The processor 20 is adapted to encapsulate data from both interfaces and deliver the data packets over a single serial interface 24 to the PDA 16.

The PDA 16 comprises an application module 22 containing an application, such as, for example, a PDA virtual corn port application, that is adapted to receive the transmitted multiplexed input and wireless information, and forward the received multiplexed input and wireless information to applicable programs and applications utilized by the PDA. The received multiplexed data entry module input and wireless information may be contemporaneously and/or independently forwarded to the applicable programs and applications. Such programs and applications include gaming, document, stock and calendar programs. The PDA 16 hosts the application that receives the data packets and forwards them to the appropriate application(s) that require keyboard, gaming keys, and/or wireless data support. The processor 20 is coupled to the interface 13 via, for example, the serial interface 24 and the interface to the application module 22 is provided via serial communication protocols.

In various other preferred embodiments, the peripheral data entry device 10, 18 may further comprise an antenna (not shown) disposed in the housing 11, 15 and coupled to the wireless modem 14 (the antenna may further be disposed within the wireless modem), and may also comprise a power source (not shown) disposed in the housing and coupled to the processor 20 and the wireless modem 14. The PDA's 16 internal or external power supply (not shown) should provide enough power for the peripheral data entry device 10, 18, but there may be certain scenarios that require additional processing capability thereby necessitating the need for the power source to be disposed within the housing 11, 15. The peripheral data entry device 10, 18 may further comprise a memory (not shown) disposed in the housing 11, 15 and coupled to the processor 20, and wherein the wireless modem 14 may also be coupled to the interface 13. The wireless modem 14 may further be configured to receive software instructions altering, adding, and/or deleting certain modem functionality. Also, in additional scenarios, other functionality can be provided via firmware upgrades.

In addition to receiving information from the data network, the wireless modem 14 is adapted to wirelessly transmit information generated from the PDA 16 to the data network. In a gaming scenario, for example, a user can utilize the wireless modem 14 to send and receive wireless information to and from the data network related to at least one of a following item: network information, games, game information, user/player information, user/player actions, ordering information, and billing information.

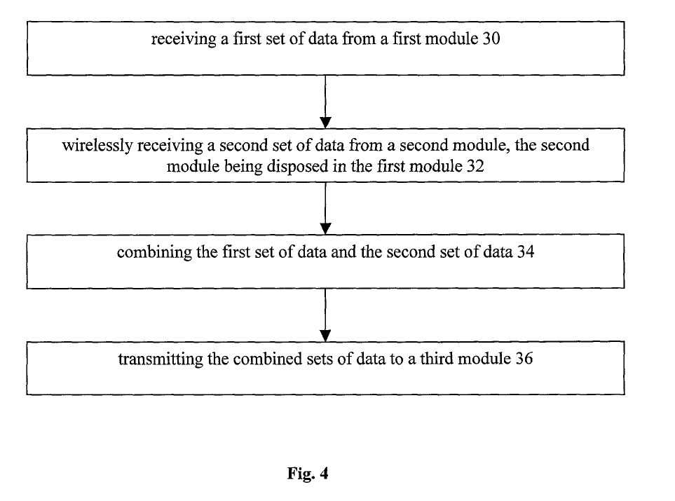

Referring now to FIG. 4, a method for data delivery is presented. The method begins by receiving a first set of data from a first module (such as, for example, the peripheral data entry device) at step 30 and wirelessly receiving a second set of data from a second module (such as, for example, the wireless modem), the second module being disposed in the first module, at step 32. The method proceeds to steps 34 and 36 where combining the first set of data and the second set of data and transmitting the combined sets of data to a third module (such as, for example, the PDA), respectively occur. In an alternate embodiment, the method may include a step of performing an action, by the third module, based on the transmitted combined sets of data.

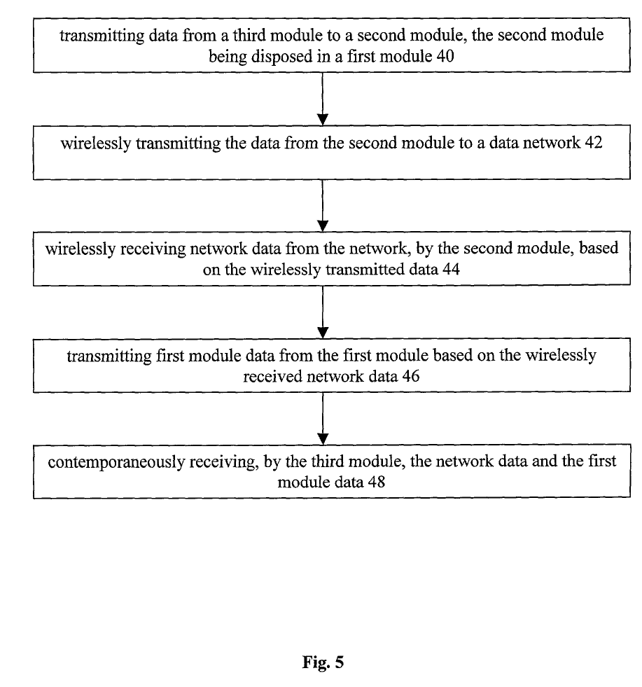

Referring now to FIG. 5, another method for data delivery is presented. The method begins at step 40 by transmitting data from a third module to a second module, the second module being disposed in a first module. At steps 42 and 44, wirelessly transmitting the data from the second module to a data network, and wirelessly receiving network data from the network, by the second module, based on the wirelessly transmitted data, respectively occur. The method proceeds to steps 46 and 48 where transmitting first module data from the first module based on the wirelessly received network data, and contemporaneously receiving, by the third module, the network data and the first module data, respectively occur. In an alternate embodiment, the method may include a step of performing an action, by the third module, based on the contemporaneously received network data and first module data.

The preceding method steps may be instructions performed by a computer readable medium. The computer readable medium may be the processor 20 or another module (not shown) in the peripheral data entry device 10, 18 and/or the PDA 16, and the instructions may be stored in the PDA's memory (not shown), the processor 20, and/or in a peripheral data entry device 10, 18 memory (not shown).

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

What we claim is:

1. A peripheral data entry device comprising:
a housing including an interface adapted to couple to a personal digital assistant (PDA);
a processor disposed in the housing and coupled to the interface;
a keyboard; and
a wireless modem disposed in the housing and adapted to wirelessly receive information from a data network;
the keyboard and the wireless modem being coupled to the processor; and
the processor being adapted to:
receive keyboard input via the keyboard;
receive the wireless information via the wireless modem;
multiplex the received keyboard input and the received wireless information; and
transmit the multiplexed keyboard input and wireless information to the PDA via the interface.

2. The peripheral data entry device of claim 1, wherein the PDA comprises an application adapted to:
receive the transmitted multiplexed keyboard input and wireless information; and
forward the received multiplexed keyboard input and wireless information to applicable programs utilized by the PDA.

3. The peripheral data entry device of claim 1 further comprising an antenna disposed in the housing and coupled to the modem.

4. The peripheral data entry device of claim 1 further comprising a power source disposed in the housing and coupled to the processor and the modem.

5. The peripheral data entry device of claim 1 further comprising a memory disposed in the housing and coupled to the processor.

6. The peripheral data entry device of claim 1, wherein the modem is coupled to the interface.

7. The peripheral data entry device of claim 1, wherein the keyboard is coupled to the processor via a serial interface.

8. The peripheral data entry device of claim 1, wherein the wireless modem is coupled to the processor via a serial interface.

9. The peripheral data entry device of claim 1, wherein the processor is coupled to the interface via a serial interface.

10. The peripheral data entry device of claim 1, wherein the wireless modem is adapted to wirelessly transmit information from the PDA to the data network.

11. A peripheral data entry device comprising:
a housing including an interface adapted to couple to a personal digital assistant (PDA);
a processor disposed in the housing and coupled to the interface;
gaming keys; and
a wireless modem disposed in the housing and adapted to wirelessly receive information from a data network;
the gaming keys and the wireless modem being coupled to the processor; and
the processor being adapted to:
receive gaming input via the gaming keys;
receive the wireless information via the wireless modem;
multiplex the received gaming input and the received wireless information; and
transmit the multiplexed gaming input and wireless information to the PDA via the interface.

12. The peripheral data entry device of claim 11, wherein the PDA comprises an application adapted to:
receive the transmitted multiplexed gaining input and wireless information; and
forward the received multiplexed gaming input and wireless information to applicable gaming programs utilized by the PDA.

13. The peripheral data entry device of claim 11, wherein the wireless information received from the data network includes at least one of a following item:
network information;
games;
game information;
player information;
player actions;
ordering information; and
billing information.

14. The peripheral data entry device of claim 11, wherein the wireless modem is adapted to wirelessly transmit gaming information from the PDA to the data network.

15. A peripheral data entry device comprising:
a housing including an interface adapted to couple to a digital device;
a processor disposed in the housing and coupled to the interface via a serial interface;
a data entry module;
a wireless modem disposed in the housing and adapted to wirelessly receive information from a data network;
an antenna disposed in the housing and coupled to the modem; and
a power source disposed in the housing and coupled to the processor and the modem;
the data entry module and the wireless modem being coupled to the processor via a serial interface; and
the processor being adapted to:
receive data entry module input via the data entry module;
receive the wireless information via the wireless modem;
multiplex the received data entry module input and the received wireless information; and
transmit the multiplexed data entry module input and wireless information to the digital device via the interface.

16. The peripheral data entry device of claim 15, wherein the digital device is adapted to:
receive the combined data entry module input and wireless information; and
forward the received combined data entry module input and wireless information to applicable programs utilized by the digital device.

17. The peripheral data entry device of claim 16, wherein the received combined data entry module input and wireless information are contemporaneously forwarded to the applicable programs.

18. The peripheral data entry device of claim 16, wherein the received combined data entry module input and wireless information are independently forwarded to the applicable programs.

19. A method for data delivery, the method comprising:
receiving a first set of data from a first module;
wirelessly receiving a second set of data from a second module, the second module being disposed in the first module;
combining the first set of data and the second set of data; and
transmitting the combined sets of data to a third module.

20. The method of claim 19 further comprising performing an action, by the third module, based on the transmitted combined sets of data.

21. A method for data delivery, the method comprising:
transmitting data from a third module to a second module, the second module being disposed in a first module;
wirelessly transmitting the data from the second module to a data network;
wirelessly receiving network data from the network, by the second module, based on the wirelessly transmitted data;
transmitting first module data from the first module based on the wirelessly received network data; and
contemporaneously receiving, by the third module, the network data and the first module data.

22. The method of claim 21 further comprising performing an action, by the third module, based on the contemporaneously received network data and first module data.
